(19) United States
(12) Patent Application Publication
(10) Pub. No.: US 2012/0014642 A1
(43) Pub. Date: Jan. 19, 2012

(54) Transparent Optical Switch

(76) Inventors: Raymond J. Hanneman, JR., New Berlin, WI (US); Alan L. Sidman, Wellesley, MA (US)

(21) Appl. No.: 12/835,818

(22) Filed: Jul. 14, 2010

(51) Int. Cl. G02B 6/26; B05D 5/06; B05D 5/12

(52) U.S. Cl. 385/16; 427/58; 216/13

(57) ABSTRACT

An optical switching device realized on a substrate. The device includes a moveable platform driven by electrostatic actuation provided by a set of rotor fingers and stator fingers. The moveable platform, rotor fingers and stator fingers are integrally formed on the substrate. The device further includes a plurality of stationary input polymeric waveguides as well as a plurality of stationary output polymeric waveguides integrally formed on the substrate. At least one polymeric waveguide is integrally formed on the moveable platform. The polymeric waveguide of the moveable platform is operably coupled to a select one of the stationary input polymeric waveguides and a select one of the stationary output polymeric waveguides in different positions of the moveable platform as driven by electrostatic actuation provided by the rotor fingers and stator fingers. The stationary input polymeric waveguides, the stationary output polymeric waveguides and the polymeric waveguide formed on the movable platform are each defined by a multilayer polymer sandwich for guiding light propagating therein. The rotor fingers and stator fingers comprise a patterned conductive material. This same conductive material is disposed under the multilayer polymer sandwich of the polymer waveguide formed on the moveable platform over its entire length.

### BACKGROUND OF THE INVENTION

1. Field of the Invention

This invention relates broadly to transparent optical switches. More particularly, this invention relates to transparent optical switches employing moveable waveguide microstructures.

2. State of the Art

Optical switches are used in optical networks for a variety of applications. One application of optical switches is in provisioning of light paths. In this application, the switches are used to form optical cross-connect architectures which can be readily reconfigured to support optical signal routing. Optical switches predominantly employ two types of signal switching: electrical switching and transparent optical switching.

In electrical switching, the optical signals are first converted into electrical signals, and then switched to the designated channel by integrated circuits. Lastly, the electrical signals are converted back into optical signals before the signals can be passed to the desired destination. Such electrical switching systems are reliable and permit signal reconditioning and monitoring. However, the optical-to-electrical conversion and electrical-to-optical conversion of such electrical switching systems are costly to implement. Moreover, most electrical switching systems are designed for a particular wavelength, data rate and signal format. Thus, any change to these design parameters requires an upgrade or replacement of the system.

In transparent optical switching, one or more moveable mirrors or waveguides are used to selectively provision the path(s) for optical signals through the switch. Such transparent optical switching systems can operate without regard to the particular data rate and signal format of the optical signal. And can also be designed to handle a wide range of wavelengths of the optical signal. In this manner, the transparent optical switching systems can accommodate updates to data rates, signal formats and wavelengths of the optical signals and thus avoid upgrade or replacement of the system.

Electrical switching is based on mature integrated circuit technology. On the other hand, optical switching depends on technologies that are relatively new. The use of micromachining is one such new approach. The term MEMS (Micro Electro-Mechanical Systems) is used to describe devices made using wafer fabrication process by micromachining (mostly on silicon wafers). The batch processing capabilities of MEMS enable the production of these devices at low cost and in large volume.

MEMS-based optical switches can be largely grouped into four categories:
1) silicon mirrors,
2) moveable waveguide microstructures,
3) fluid switches, and
4) thermal-optical switches.

Both fluid and thermal-optical switches have been demonstrated, but these technologies lack the ability to scale up to a high number of channels or port counts. A high port count is important to efficiently switch a large number of optical signals. Thus, silicon mirrors and moveable waveguide microstructure are approaches where a high port count is achievable.

Transparent optical switching with the use of silicon mirrors is challenging. These systems require very tight angular control of the beam path and a large free space distance between reflective mirrors in order to create a device with high port counts. The precise angular controls required are typically not achievable without an active control of beam paths. Since each path has to be monitored and steered, the resulting system can be complex and costly. These systems also require substantial software and electrical (processing) power to monitor and control the position of each mirror. Since the mirror can be moved in two directions through an infinite number of possible positions (i.e., analog motion), the resulting feedback acquisition and control system can be very complex, particularly for a switch having large port counts.

Transparent optical switching with the use of moveable waveguide microstructures has also been proposed. Such a system greatly simplifies the operation of switching, enhances reliability and performance, while significantly lowering cost. However, such systems can suffer from high insertion loss, a parameter that measures the amount of light lost as a result of optical signal traversing through the switch. Many factors contribute to such insertion loss, including loss due to coupling between fiber and the waveguide microstructures of the switch, loss due to absorption of light in the waveguide material, and loss due to light traversing in a curved path or around corners.

### SUMMARY OF THE INVENTION

The problems of the prior art are solved by the present invention, which is directed to an optical switching device realized on a substrate. The device includes a moveable platform driven by electrostatic actuation provided by a set of rotor fingers and stator fingers. The moveable platform, rotor fingers and stator fingers are integrally formed on the substrate. The device further includes a plurality of stationary input polymeric waveguides as well as a plurality of stationary output polymeric waveguides integrally formed on the substrate. At least one polymeric waveguide is integrally formed on the moveable platform. The polymeric waveguide of the moveable platform is operably coupled to a select one of the stationary input polymeric waveguides and a select one of the stationary output polymeric waveguides in different positions of the moveable platform as driven by electrostatic actuation provided by the rotor fingers and stator fingers. The stationary input polymeric waveguides, the stationary output polymeric waveguides and the polymeric waveguide formed on the movable platform are each defined by a multilayer polymer sandwich for guiding light propagating therein. The rotor fingers and stator fingers comprise a patterned conductive material that also realizes contacts pads as well as electrical connections between the stator and rotor fingers and the pads. The patterned conductive material carries electrical signals supplied to the pads induce the electrostatic actuation forces between the stator and rotor fingers in order to produce the desired movement of the moveable platform. This same conductive material is disposed under the multilayer polymer sandwich of the polymer waveguide formed on the moveable platform over its entire length.

It will be appreciated that the patterned conductive material disposed under the multilayer polymer sandwich of the polymer waveguide formed on the moveable platform provides structural support to counteract the mechanical stresses imparted on the polymeric conductive waveguide during movement of the platform over the operational lifetime of the device. It also provides a uniform surface underlying the polymer waveguide structure, which limits deformation of the overlying waveguide structure and any optical loss that may result therefrom.

In the preferred embodiment, a sacrificial oxide layer is deposited on or part of the substrate. In this preferred embodiment, the moveable platform and rotor fingers are part of a rigid body suspended over the substrate by etching of the sacrificial oxide layer. The rigid body also preferably includes mechanical suspension (referred to as “suspenders” herein) that extend between the moveable platform and corresponding anchors that are rigidly coupled to the substrate.

In the preferred embodiment, the multilayer polymer sandwich of the polymeric waveguides of the device are realized from a polymer selected from the group consisting of: co-polymers of tetrafluoroethylene (TFE) and 2,2,4-trifluoro-5-trifluoromethoxy-1,3-dioxole (TTD); and a perfluoroploymer. The perfluporopolymer preferably includes randomly copolymerized units of tetrafluoroethylene, perfluoro (alkyl vinyl) ether and a cure site monomer. The cure site monomer is preferably selected from the group consisting of: vinyldene fluoride; perfluoro-(8-cyano-5-methyl-3,6-dioxa-1-octene, bromotetrafluorobutene); perfluoro-(2-phenoxypropyl vinyl ether); and poly(perfluorinated butenyl vinyl ether).

In an illustrative embodiment, a metal mask layer (e.g., an aluminum mask) overlies the multilayer polymer sandwich.

Gaps separate the polymeric waveguides of the device. In the illustrative embodiment, such gaps have a maximum dimension less than 5 μm, more preferably less than 2.5 μm, and most preferably in the range between 1.5 μm and 2 μm. Such small-size gaps limit optical loss. Moreover, such gaps can be filled by an index matching fluid in order to further limit optical loss.

In the preferred embodiment, the multilayer polymer sandwich of the waveguides of the device is realized from a polymer core sandwiched between an upper polymer cladding and a lower polymer cladding. The thickness of the lower cladding for the polymeric waveguides of the device can be controlled over the polymeric waveguides to provide for vertical alignment of the polymeric waveguides of the device. Alternatively, a buffer layer can be disposed under the lower cladding of certain polymeric waveguides of the device to provide for vertical alignment of the polymeric waveguides of the device.

A micromachining method of fabrication of an optical switching device is also disclosed and claimed. The method includes
depositing and patterning a conductive material on a substrate;
depositing and patterning a multilayer polymer sandwich, wherein first and second parts of the patterned multilayer polymer sandwich are formed over the substrate and operate to guide light propagating therein, and a third part of the patterned multilayer polymer sandwich is formed over the patterned conductive material and operate to guide light propagating therein; and
covering the first, second and third parts of the patterned multilayer polymer sandwich with protective material while forming a moveable platform as well as a set of rotor fingers and stator fingers on the substrate, wherein the rotor fingers and stator fingers provide for electrostatic actuation of the moveable platform and include the patterned conductive material. The first and second parts of the patterned multilayer polymer sandwich define a plurality of stationary input polymeric waveguides as well as a plurality of stationary output polymeric waveguides, and the third part of the patterned multilayer polymer sandwich defines a polymeric waveguide integral to the moveable platform.

The patterned conductive material realizes contact as well as electrical connections between the stator and rotor fingers and the pads. The patterned conductive material carries electrical signals supplied to the pads that induce the electrostatic actuation forces between the stator and rotor fingers in order to produce the desired movement of the moveable platform. In the preferred embodiment, the patterned conductive material is disposed under the multilayer polymer sandwich of the polymer waveguide integral to the moveable platform over its entire length. It will be appreciated that the patterned conductive material disposed under the multilayer polymer sandwich of the polymer waveguide formed on the moveable platform provides structural support to counteract the mechanical stresses imparted on the polymeric conductive waveguide during movement of the platform over the operational lifetime of the device. It also provides a uniform surface underlying the polymer waveguide structure, which limits deformation of the overlying waveguide structure and any optical loss that may result therefrom.

In the preferred embodiment, a sacrificial oxide layer is deposited on or is part of the substrate, and etching of the sacrificial oxide layer is used to define a rigid body suspended over the substrate, wherein the rigid body includes the moveable platform and rotor fingers. The rigid body also preferably includes suspenders that extend between the moveable platform and corresponding anchors that are rigidly coupled to the substrate.

In the preferred embodiment, the protective material protects the underlying patterned multilayer polymer sandwich from etchant used in the etching of the sacrificial oxide layer. For example, in the case that the etchant is an HF etchant, the protective material of photoresist is suitable.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level schematic diagram of an exemplary MEMS-based transparent optical switching device in accordance with the present invention.

FIG. 2A is a schematic diagram of an exemplary embodiment of the electrostatic comb drive actuator of the optical switching device of FIG. 1.

FIG. 2B is a detailed view of a portion of the comb drive actuator of FIG. 2A.

FIG. 3 is a schematic electrical diagram of the electrostatic comb drive actuator of FIG. 2A.

FIGS. 4A and 4B are diagrams illustrating the rotational actuation provided by the comb drive actuator of FIG. 2A.

FIGS. 5A-5H(iii) are schematic illustrations of an exemplary micromachining manufacturing process for fabricating the optical switching device of FIGS. 1 and 2A. The fabrication of the rotating platform of the device as part of the process is shown particularly in FIGS. 5C(i), 5D(i), 5E(i), 5F(i), 5G(i), and 5H(i). The fabrication of the stator and rotor fingers of the device as part of the process is shown particularly in FIGS. 5C(ii), 5D(ii), 5E(ii), 5F(ii), 5G(ii), and 5H(ii). The fabrication of the input and output stationary polymeric waveguides of the device as part of the process is shown particularly in FIGS. 5C(iii), 5D(iii), 5E(iii), 5F(iii), 5G(iii), and 5H(iii).

FIG. 6 is a schematic illustration of the structure resulting from the manufacturing process of FIGS. 5A-5H(iii), particularly illustrating the gaps between the polymeric waveguide of the rotating platform and the respective stationary waveguide structure in different rotative positions of the platform.

FIG. 7A is a cross-sectional schematic side view of an exemplary off-chip interconnect used as part of the optical switching device of FIGS. 1 and 2A.

FIG. 7B is a schematic top view of the off-chip interconnect of FIG. 7A.

FIG. 8A is a cross-sectional schematic side view of another exemplary off-chip interconnect used as part of the optical switching device of FIGS. 1 and 2A.

FIG. 8B is a schematic top view of the off-chip interconnect of FIG. 8A.

### DETAILED DESCRIPTION OF THE PREFERRED EMBODIMENTS

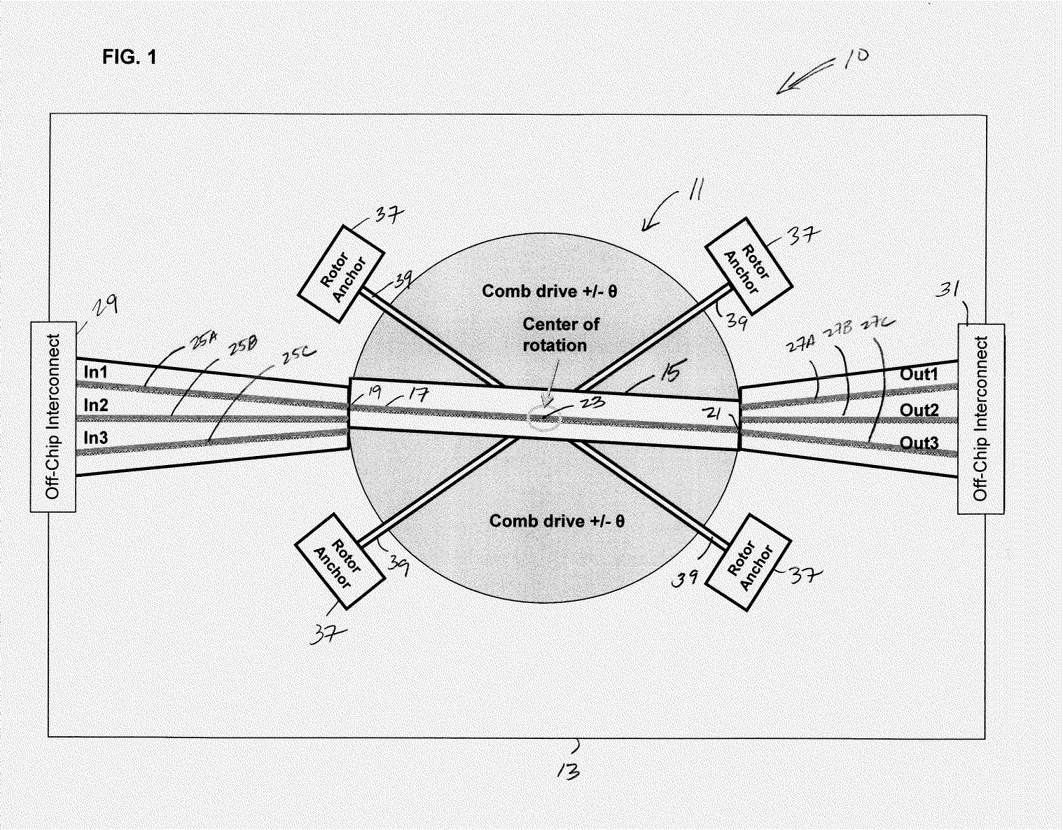

Turning now to FIG. 1, there is shown an exemplary optical switching device 10 in accordance with the present invention that employs three inputs (labeled “In1”, “In2”, In3”) and three outputs (labeled “Out1”, Out2”, “Out3”). The device 10 includes a rotary comb drive actuator 11 integrally formed on a substrate 13. The rotary comb drive actuator 11 defines a rotatable platform 15 supporting a polymeric waveguide structure 17 integrally formed thereon having an ingress end 19 disposed opposite an egress end 21. The rotatable platform 15 is rotated about a rotational axis 23 normal to the substrate 13 (out of the page in FIG. 1) into a number of rotative positions by the supply of electrical signals to the rotary comb drive actuator 11.

Three stationary ingress polymeric waveguide structures 25A, 25B, 25C (which correspond to the three inputs) as well as a three stationary egress polymeric waveguide structures 27A, 27B, 27C (which correspond to the three outputs) are integrally formed on the substrate. In the rotative positions of the platform 15, a select one of the ingress polymeric waveguide structures (25A, 25B or 25C) interface to the ingress end 19 of the polymeric waveguide structure 17 supported on the platform 15 to provide for optical coupling of the selected ingress polymer waveguide structure (25A, 25B or 25C) to the ingress end 19 of the polymeric waveguide structure 17. In such rotative positions, the egress end 21 of the polymeric waveguide structure 17 selectively interfaces to one of the egress polymeric waveguide structures (27A, 27B or 27C) to provide for optical coupling between the egress end 19 of the polymeric waveguide structure 17 and the selected egress polymer waveguide structure (27A, 27B, or 27C).

An ingress coupling mechanism 29 interfaces to the respective ingress polymeric waveguide structures 25A, 25B, 25C and guides ingress optical signals (not shown) to the respective ingress polymeric waveguide structures 25A, 25B, 25C. Similarly, an egress coupling mechanism interfaces to the respective egress polymeric waveguide structures 27A, 27B, 27C and guides egress optical signals (not shown) supplied by the respective egress polymeric waveguide structures 27A, 27B, 27C.

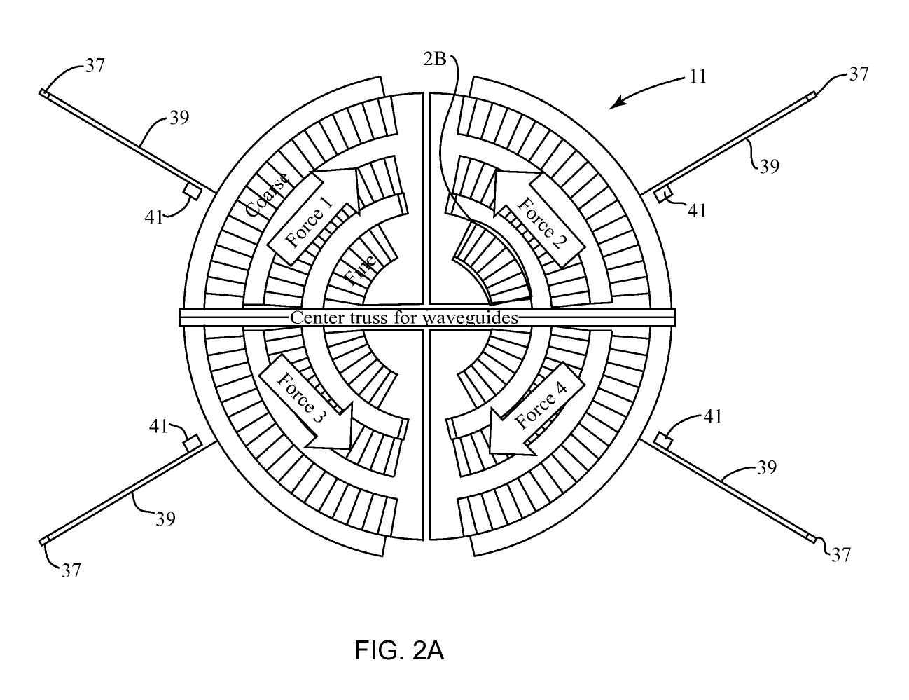

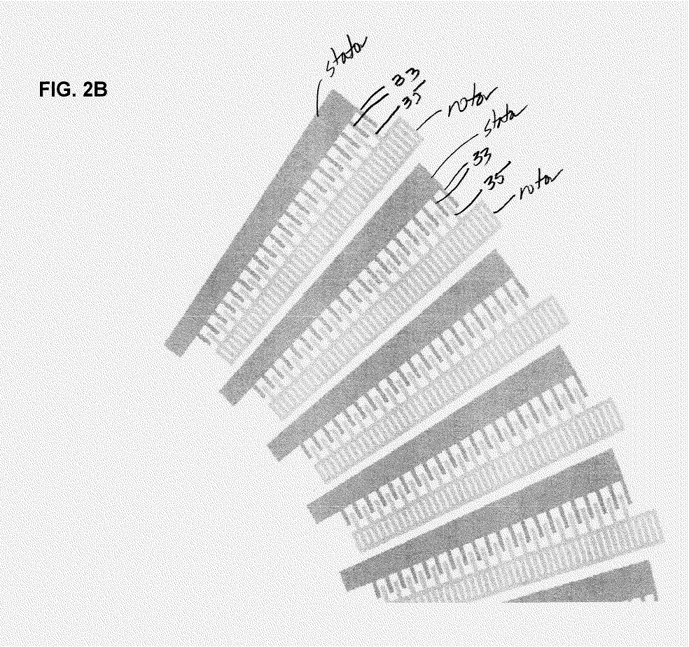

A best shown in FIG. 2B, the rotary comb drive actuator 11 includes a plurality of stationary comb fingers 33 (referred to herein as “stator fingers”) that are interdigitated with respect to a plurality of rotatable comb fingers 35 (referred to herein as “rotor fingers”). Both the stator fingers and rotor fingers are integrally formed on the substrate 13. The rotor fingers 35 and rotatable platform 15 are formed as part of a rigid body that is suspended above the substrate 13 in a manner that allows for rotation about the rotational axis 23.

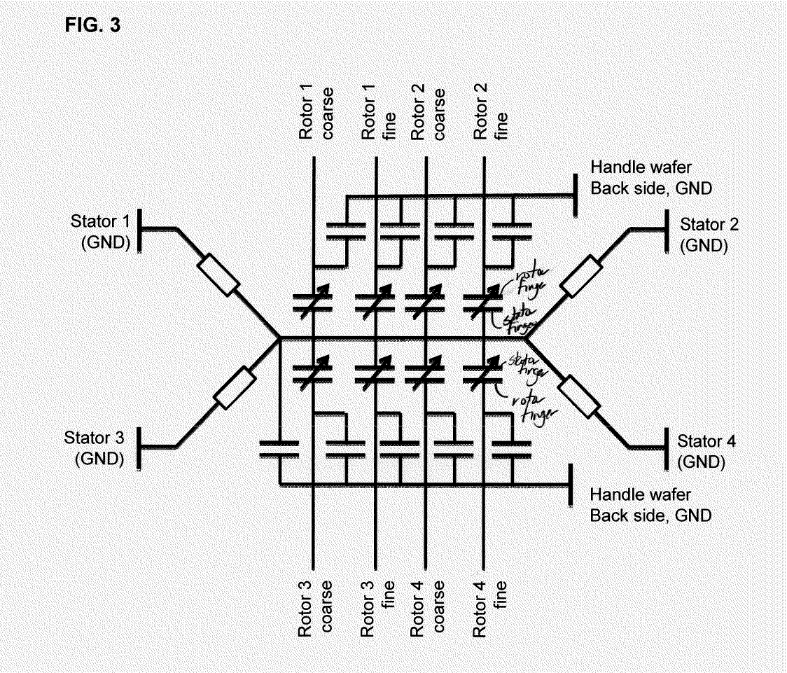

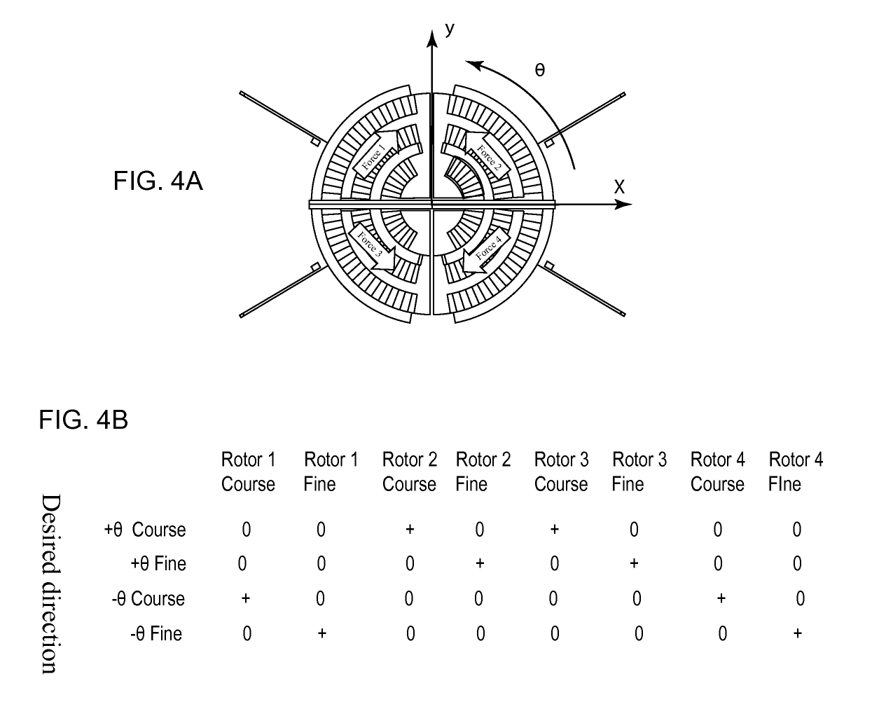

In the preferred embodiment as shown in FIG. 2A, the stator fingers 33 and rotor fingers 35 are grouped into four quadrants about the rotational axis that provide for both course and fine rotational movement about the rotational axis 23 in both a clockwise and counterclockwise manner. More specifically, the first quadrant (which is overlaid with the label “Force 1”) includes a set of stator and rotor fingers that provide for course and fine rotational movement in the clockwise direction. The second quadrant (which is overlaid with the label “Force 2”) includes a set of stator and rotor fingers that provide for course and fine rotational movement in the counterclockwise direction. The third quadrant (which is overlaid with the label “Force 3”) includes a set of stator and rotor fingers that provide for course and fine rotational movement in the counterclockwise direction. The fourth quadrant (which is overlaid with the label “Force 4”) includes a set of stator and rotor fingers that provide for course and fine rotational movement in the clockwise direction. The rotatable platform 15 is controlled by application of voltage signals to the rotor fingers and stator fingers of the four quadrants as depicted in FIG. 3. Polarities of the exemplary voltage signals for controlling course and fine rotational movement in the clockwise direction (+θ) as well as the counter-clockwise direction (−θ) are provided in FIGS. 4A and 4B.

Moreover, the rotary comb drive actuator 11 preferably includes anchors 37 that are formed above the substrate 15 and rigidly secured thereto. The anchors 37 are mechanically coupled to suspenders 39 that are formed as part of the rigid body that defines the rotatable platform 15 and rotor fingers 35 of the actuator 11. The anchors 37 and suspenders 39 cooperate to limit up/down movement (i.e., movement out of the plane of rotation) of the rotatable platform 15 and rotor fingers 35 while suspending the platform 15 above the substrate in a manner that allows for desired rotational movement of the rotatable platform 15 and rotor fingers 35.

The stator fingers 33 and the rotor fingers 35 of the actuator 11 are realized from a patterned conductive material (for example, a patterned metal layer or stack) that provides capacitance for inducing electrostatic forces between adjacent fingers for driving rotational movement of the rotatable platform. In an exemplary embodiment, the patterned conductive material is realized by a thin aluminum layer. The patterned conductive material of the stator fingers 33 and rotor fingers 35 also realizes a set of contact pads 41 as well as electrical connections between the stator fingers 33 and rotor fingers 35 and the pads 41. Electrical signals are supplied to the pads 41 to provide a voltage difference between adjacent stator and rotor fingers that induces electrostatic forces therebetween in order to produce the desired rotational movement of the rotatable platform (FIGS. 4A and 4B).

The rigid body that defines the rotatable platform 15, rotor fingers 35 and suspenders 39 of the actuator 11 is suspended above the substrate 13 by a fabrication process that employs a sacrificial oxide layer that is disposed under the rigid body (and possibly surrounding the rigid body). An etch is performed to expose the sacrificial oxide layer. This etch can be realized by highly anisotropic reactive-ion etching (for example, the Bosch process). The exposed sacrificial oxide layer is then removed by a vapor HF process or other suitable process to thereby define the rigid body such that it is suspended above the substrate. The sacrificial oxide can be deposited and patterned as part of the fabrication process or can be a buried oxide layer integral to an epitaxial layer structure formed on the substrate as is common of many commercially available silicon-on-insulator (SOI) micromachining processes.

The polymeric waveguide structure 17 of the rotatable platform 15 as well as the ingress polymeric waveguide structures 25A, 25B, 25C and the egress polymeric waveguide structures 27A, 27B, 27C are integrally formed on the substrate by deposition and etching (or liftoff).

According to the present invention, the conductive material that is patterned to realize the stator fingers 33 and rotor fingers 35 of the actuator 11 (as well as the contact pads and the electrical connections therebetween) is simultaneously deposited and patterned in a predetermined area that is designed to underlie the polymeric waveguide structure 17 of the rotatable platform along its entire length. The polymeric waveguide structure 17 is then formed on this patterned conductive material. In this manner, the patterned conductive material underlies and supports the polymeric waveguide structure 17 of the rotatable platform 15 along its entire length. Advantageously, the underlying patterned conductive material provides structural support to counteract the mechanical stresses imparted on the polymeric conductive waveguide during rotational movement of the platform 15 over the operational lifetime of the device. It also provides a uniform surface underlying the polymer waveguide structure 14, which limits deformation of the overlying waveguide structure and any optical loss that may result therefrom.

In the preferred embodiment, the polymeric waveguide structures of the device consist of a polymeric core sandwiched between a lower polymeric cladding and a lower polymeric cladding. The index of refraction of the polymeric core is different from the index of refraction of the lower and upper polymeric cladding to provide for light guiding within the core. Moreover, the thickness of the lower cladding of the ingress and egress polymeric waveguide structures can be adjusted to provide for vertical alignment of the ingress and egress polymeric waveguide structures to the polymeric waveguide structure of the rotatable platform. Alternatively, a buffer layer (or the conductive material of underlying the polymeric waveguide structure of the rotatable platform) can be formed to the adjusted to provide for vertical alignment of the ingress and egress polymeric waveguide structures to the polymeric waveguide structure of the rotatable platform.

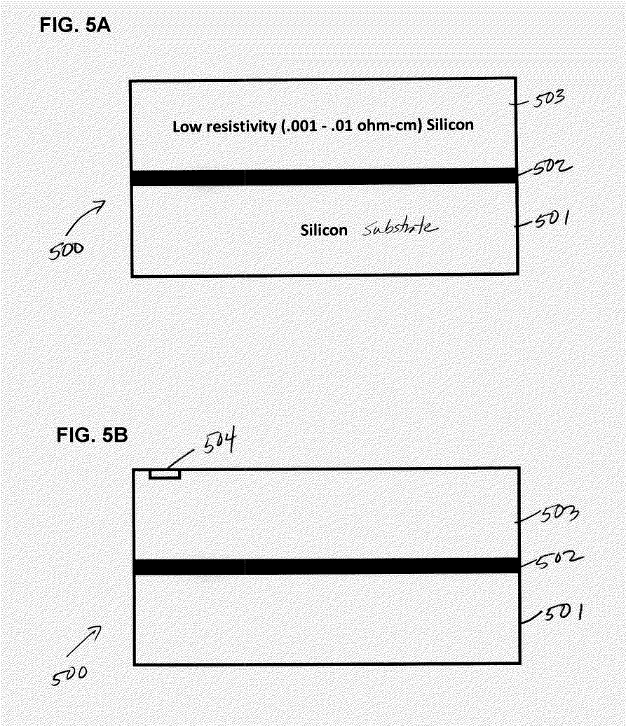

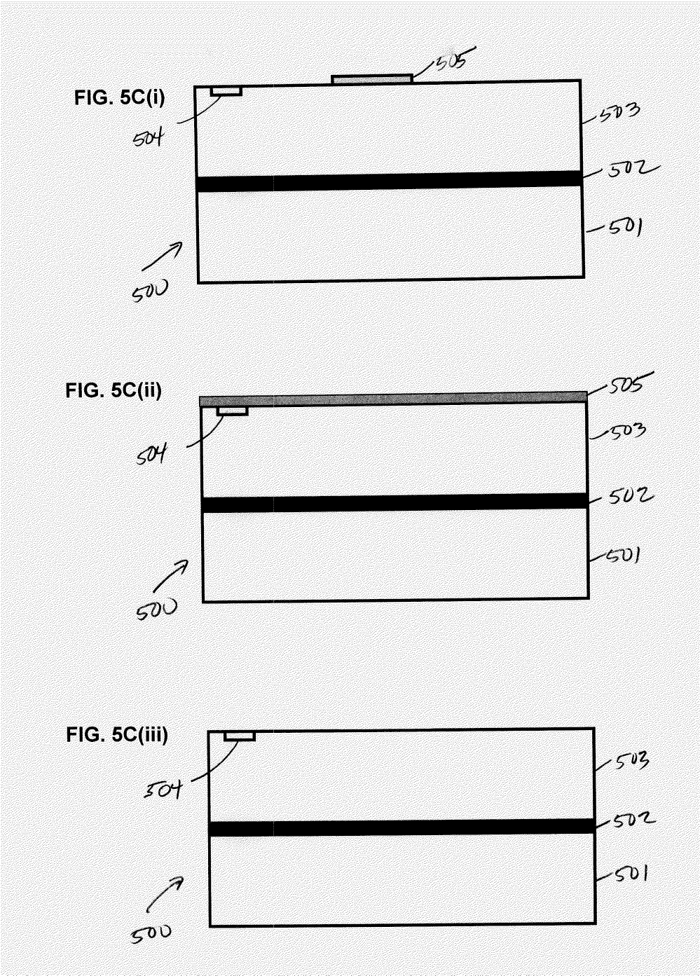

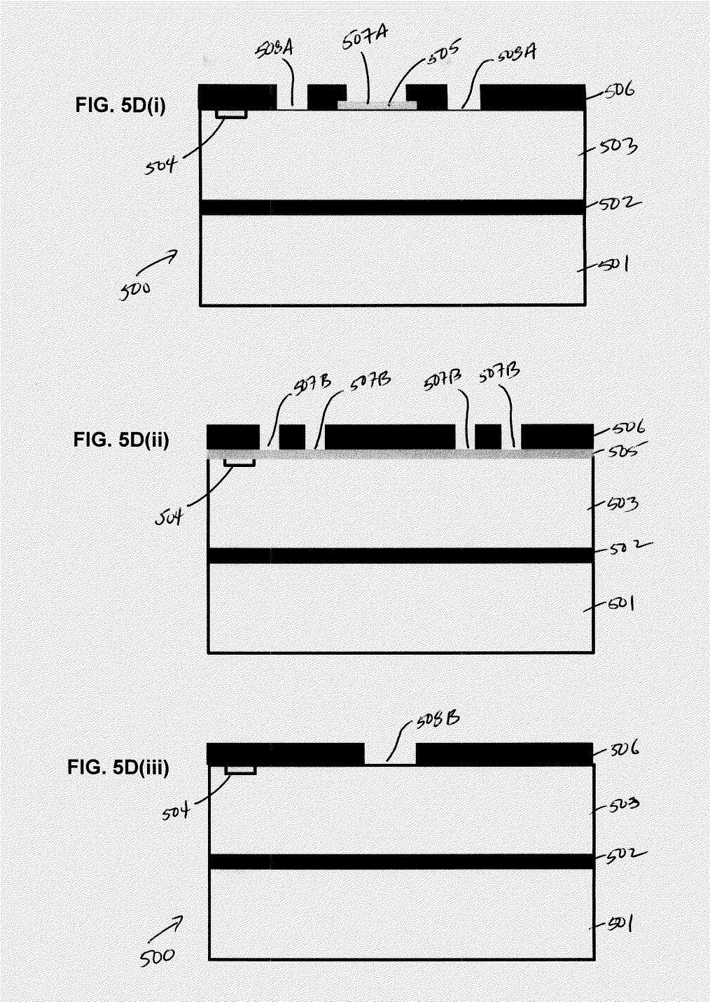

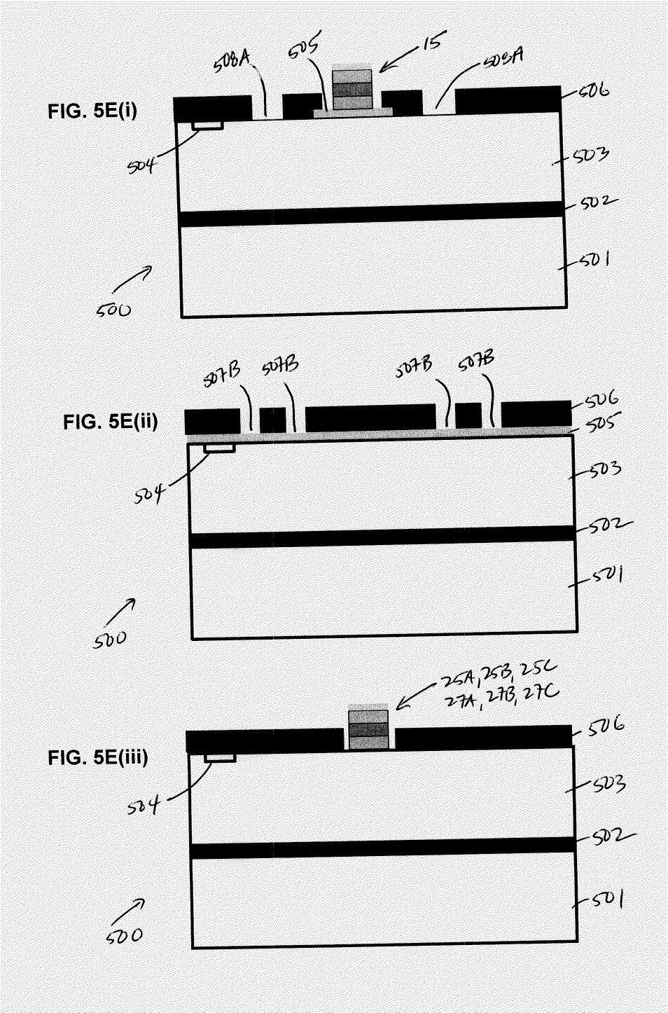

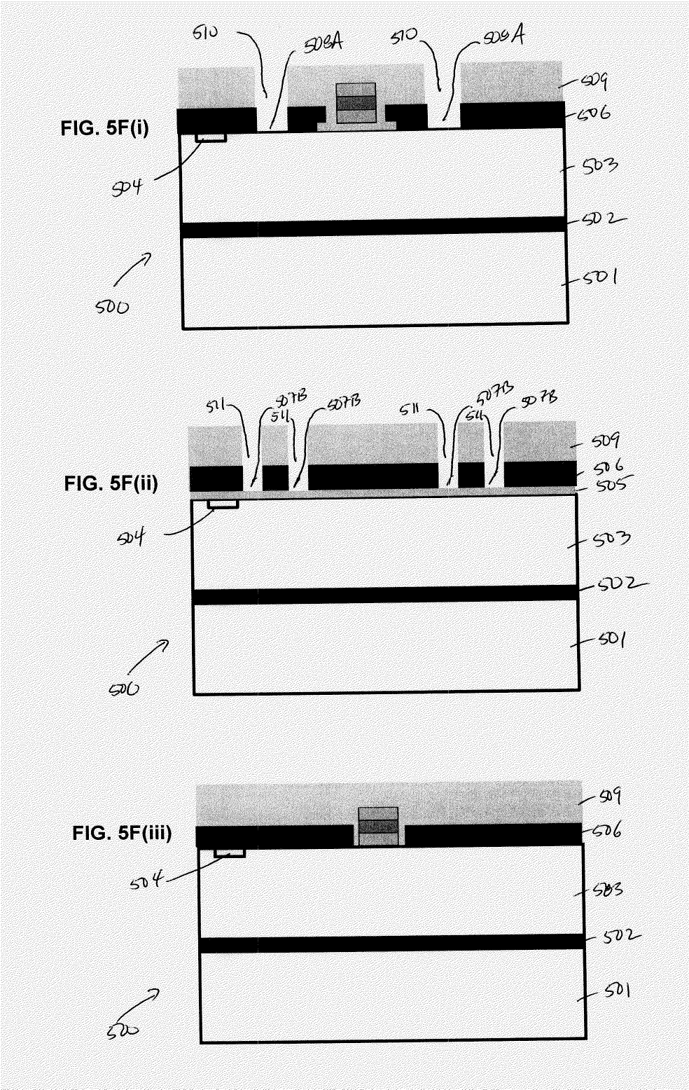

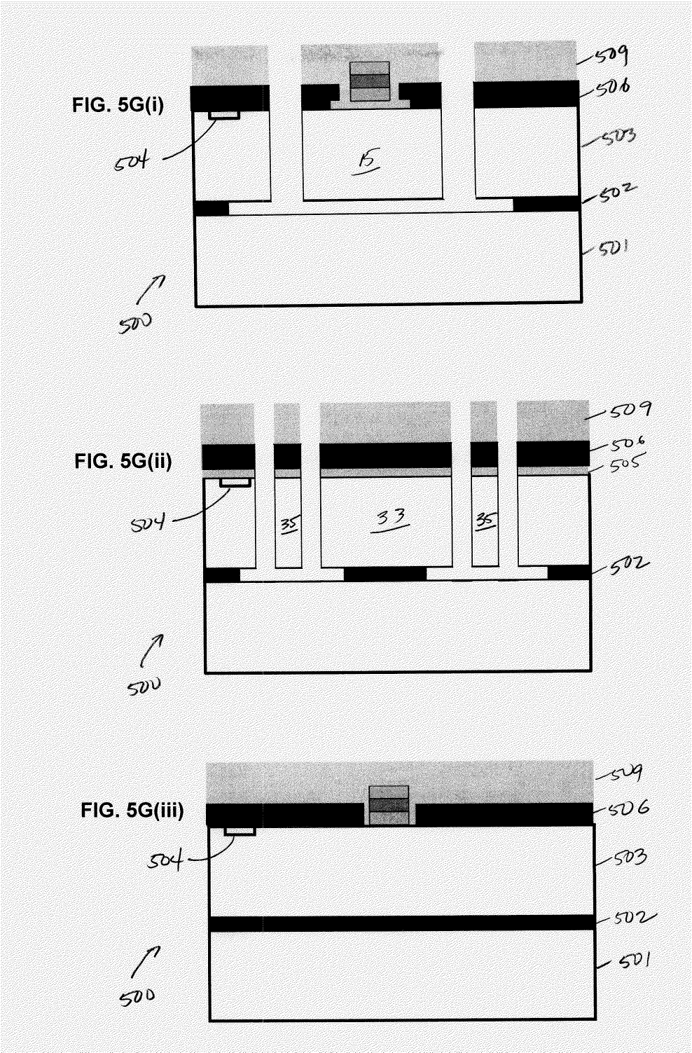

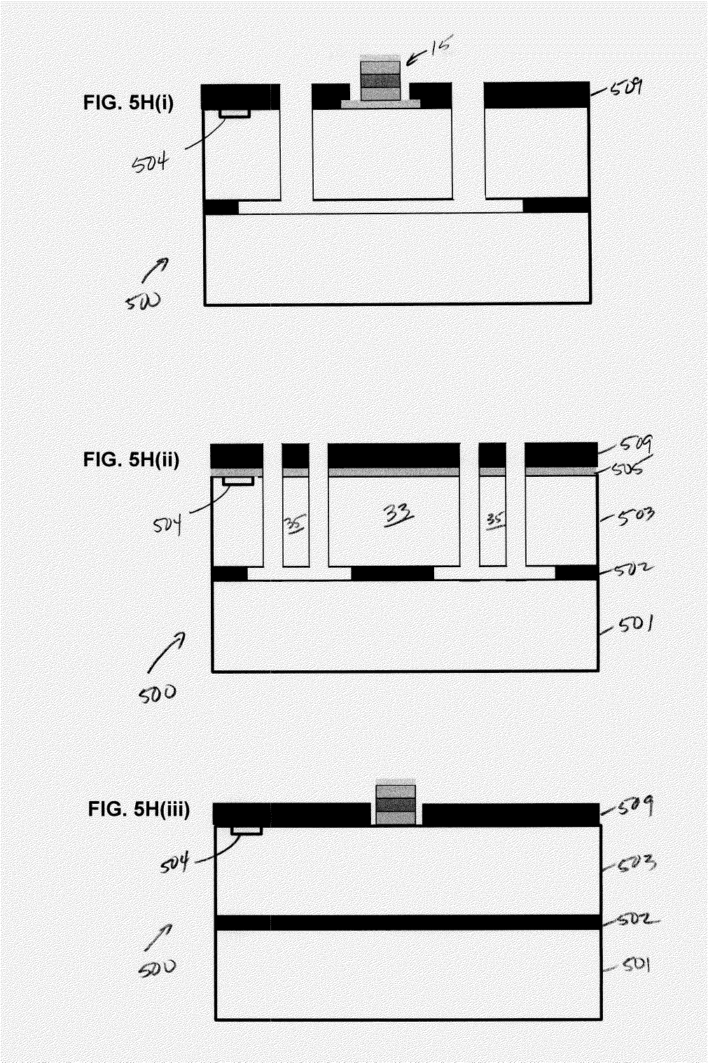

In an illustrative embodiment, the optical switching device 10 of FIG. 1 is fabricated by a micromachining manufacturing process illustrated in 5A through 5H(iii). The process begins with the provision of a standard silicon-on-insulator wafer 500 as shown in FIG. 5A. The wafer 500 includes a low resistivity silicon layer 503 (preferably 50 μm in thickness) formed on a thin buried oxide layer 502 (preferably silicon dioxide) supported on a silicon substrate 501.

As shown in FIG. 5B, global alignments marks (one shown as 504) are patterned and etched into the top silicon layer 503 of the wafer 500. Theses alignment marks are used for mask alignment in subsequent process steps as is well known.

Next, conductive material 505 (e.g., a metal or polysilicon layer or stack) is deposited and patterned on the top silicon layer 503 of the wafer 500. In an exemplary embodiment, the conductive material 505 is realized by a thin aluminum layer. The conductive material 505 is patterned such that it remains in areas that will form the stator and rotor fingers of the actuator as shown in FIG. 5C(i) as well as the contact pads 41 and the electrical connections between the contact pads and the stator and rotor fingers (not shown). In this manner, the conductive material 505 carries the electrical signals supplied to the contact pads to induce the electrostatic actuation forces between the stator and rotor fingers in order to produce the desired rotational movement of the rotatable platform 15 (FIGS. 4A and 4B).

The patterning of the conductive material 505 is adapted such that the conductive material 505 remains in areas that will underlie the polymeric waveguide structure 15 of the rotatable platform 11 as shown in FIG. 5C(ii). The conductive material 505 underlies the polymeric waveguide structure 15 along its entire length (i.e., from its ingress end 19 to its egress end 21). The patterning of the conductive material 505 is also adapted such that the conductive material 505 is omitted from areas that underlie the stationary polymeric waveguide structures 25A, 25B, 25C, 27A, 27B, 27C as shown in FIG. 5C(iii). The conductive material 505 is preferably deposited by sputtering. Alternatively, evaporation, chemical vapor deposition, electrochemical techniques or other suitable techniques can be used. The patterning of the conductive material 505 can be accomplished by etching or lift-off as is well known in the art. A pre-deposition etch may be used to remove native oxide, if needed.

Next, a mask 506 of aluminum oxide (or aluminum fluoride or other material suitable for a deep etch step as described below) is deposited and patterned on the wafer 500. Aluminum oxide is preferred due to it's etch rate selectivity versus silicon. The mask 506 is patterned to expose areas 507A and 507B of the conductive material 500. The area 507A underlies the polymeric waveguide structure 15 of the rotatable platform 11 as shown in FIG. 5D(i). The areas 507B are used to define the rotor and stator fingers via the deep etch as will become evident from the subsequent process steps.

The patterning of the mask 506 is also adapted to expose areas 508A and 508B at or near the top silicon layer 503. The areas 508A at or near the top silicon layer 503 shown in FIG. 5D(i) are used to define the platform 33 via the deep etch as will become evident from the subsequent process steps. The areas 508B at or near the top silicon layer 503 shown in FIG. 5D(iii) underlie the stationary ingress and egress polymeric waveguide structures as will become evident from the subsequent process steps. Deposition of the mask 506 can be accomplished by chemical vapor deposition or other suitable techniques. Patterning of the mask 506 can be accomplished by etching or other suitable techniques.

Next, the polymeric waveguide structures of the device (including the polymeric waveguide structure 15 of the rotatable platform 11 and the stationary ingress and egress polymeric waveguide structures) are integrally formed on the wafer 500. The polymeric waveguide structure 15 of the rotatable platform 11 is formed on the patterned conductive material 505 as shown in FIG. 5E(i). The stationary ingress and egress polymeric waveguide structures 25A, 25B, 25C, 27A, 27B, 27C are formed at or near the top silicon layer 503 as shown in FIG. 5E(iii).

In the preferred embodiment, the polymeric waveguide structures of the device consist of a polymeric core sandwiched between a lower polymeric cladding and a lower polymeric cladding. The index of refraction of the polymeric core is different from the index of refraction of the lower and upper polymeric cladding to provide for light guiding within the core. The polymeric waveguide structures can be fabricated by depositing (for example, by spin deposition) and curing the lower cladding, depositing and curing the core on the lower cladding, depositing and curing the upper cladding on the core, and then patterned etching of the resultant structure. For example, the resulting waveguide structures can be patterned by depositing and patterning an aluminum mask on the upper polymeric cladding (for example, by wet etching techniques of a patterned photoresist) followed by etching through the upper cladding, core and lower cladding with the aluminum mask defining the pattern of the polymeric waveguide structures. In the preferred embodiment, the etching of the polymeric waveguide structures is carried out by oxygen plasma etching as the oxygen plasma stops at the metal layer 505 and the silicon layer 506 and thus does not require masking of these layers (for example, in the areas 508A and 507B shown in FIGS. 5E(i) and 5E(ii)). Other suitable processes can be used to etch through the upper cladding, core and lower cladding and define the pattern of the polymeric waveguide structures.

The thickness of the claddings and core can be controlled by the spinning speed used for the spin deposition and/or control over the viscosity of the deposited polymer composition. Thicker layers can be realized by slower spinning speeds and/or higher viscosity polymer compositions. Thinner layers can be realized by higher spinning speeds and/or lower viscosity polymer compositions. Viscosity of the polymer composition can be controlled by varying the relative concentrations of polymer and solvent as part of the polymer composition. The curing can be accomplished by different means depending on the nature of the polymeric material, such as by exposure to heat or exposure to UV light for UV curable polymers. In the preferred embodiment, the polymeric waveguide structures have a cross-sectional dimension on the order of 15 μm by 15 μm, with the polymeric core of such polymeric waveguide structures having a height in the range of 3-6 μm (more preferably on the order of 4 μm).

Moreover, in the preferred embodiment, the thickness of the lower cladding of the ingress and egress polymeric waveguide structures is adjusted to provide for vertical alignment of the ingress and egress polymeric waveguide structures to the polymeric waveguide structure of the rotatable platform. Alternatively, a buffer layer (or the conductive material of underlying the polymeric waveguide structure of the rotatable platform) can be formed to the adjusted to provide for vertical alignment of the ingress and egress polymeric waveguide structures to the polymeric waveguide structure of the rotatable platform.

Low-loss polymeric materials for the core and cladding layers of the polymeric waveguide structures of the device are preferred. For example, co-polymers of tetrafluoroethylene (TFE) and 2,2,4-trifluoro-5-trifluoromethoxy-1,3-dioxole (TTD) can be used. In another example, perfluoroploymers comprising a low molecular weight perfluoropolymer having randomly copolymerized units of tetrafluoroethylene, perfluoro(alkyl vinyl) ether and a cure site monomer can be used. The cure site monomer is more preferably selected from the group consisting of: vinyldene fluoride, perfluoro (8-cyano-5-methyl-3,6-dioxa-1-octene), bromotetrafluorobutene, perfluoro (2-phenoxypropyl vinyl ether), and poly(perfluorinated butenyl vinyl ether).

Subsequent to forming the polymeric waveguide structures of the device, a mask 509 of photoresist (or other material suitable for the deep etch and release etch steps below) is deposited and patterned remove certain areas 510 and 511 of the mask 509 that are aligned with the open areas 507B and 508A defined by the patterned mask layer 506 (FIGS. 5D(i) and 5D(ii)). The open areas 510/508B and 511/507B are used to define a number of structural elements of the actuator 11. For example, the exposed areas 510/508B shown in FIG. 5F(i) are used to define the rotatable platform 11 (and other parts of the suspended rigid body such as the suspenders) of the actuator 11. In another example, the exposed areas 511/507B as shown in FIG. 5F(ii) are used to define the rotor and stator fingers of the actuator 11 as well as other features such as the anchors (not shown). Note that the patterning of the mask 509 is adapted such that it is continuous over (and thus protects) areas of the wafer 500 that define the stationary ingress and egress polymeric waveguide structures as shown in FIG. 5F(iii).

In the preferred embodiment, the open areas 510/508B and 511/507B are used in conjunction with a deep etch down to the buried oxide layer 502 of the wafer 500. The deep etch can be realized by highly anisotropic reactive-ion etching (for example, the Bosch process) to provide for steep sidewalls leading to the buried oxide layer. The deep etch is followed by a release etch of HF (liquid or gas) that removes and undercuts the buried oxide layer 503 and releases the rotor fingers, suspenders and rotatable platform 15 of the actuator such these features are suspended above the substrate (i.e., with a separation gap therebetween), while the stator fingers and anchors of the actuator remain secured to the substrate (i.e., the undercut does not provide for release of these features). The release of the rotatable platform 15 is illustrated in FIG. 5G(i). The release of the rotor fingers 35 (with the stator fingers 33 remained secured) is shown in FIG. 5G(ii). The protection of the areas of the wafer 500 that define the stationary ingress and egress polymeric waveguide structures during the deep etch and release etch is shown in FIG. 5G(iii). In the preferred embodiment, the release etch utilizes anhydrous HF vapor process where the maximum structure size to be safely released is 20 μm and the minimum structure size to be safely anchored is on the order of 150 μm. During the release etch, the patterned mask 509 and the patterned mask 506 protect against the release HF etchant and dictate the size of the structures of the actuator 11 as well as the rigid body of the platform 15.

Next, the remnants of the mask 509 are removed as shown in FIGS. 5H(i), 5H(ii), and 5H(iii). This step exposes the contact pads (not shown) of the actuator 11 for contacting to such pads as needed.

Finally, the wafer is diced along edges to form a resultant device structure. In the preferred embodiment, the ingress end of a number of ingress polymeric waveguide structures are situated along one or more the edges so formed, while the egress end of a number of egress polymeric waveguide structures are also situated along one or more of the edges so formed. The ends of such waveguide structures are polished and mated to off-chip optical couplers that guide ingress optical signals into the device and guide egress optical signals for supply to a downstream network element.

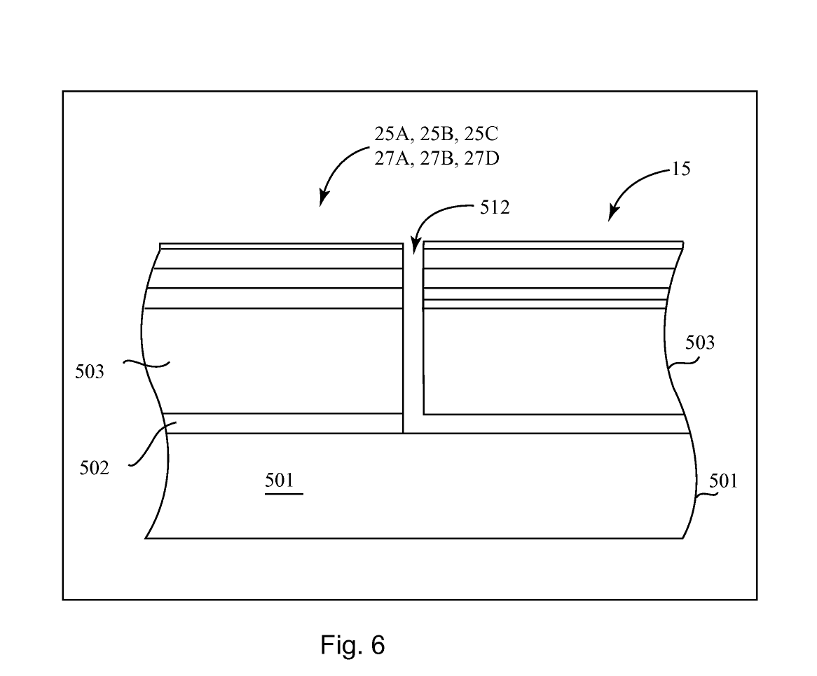

Finally, the device is preferably integrated as part of a chip-scale package. In the preferred embodiment, the chip-scale package forms a sealed cavity above the rotatable platform. The sealed cavity is filled with an index-matching fluid. This index matching fluid fills the gaps 512 between the polymeric waveguide structures in the different rotative positions of the platform in order to reduce insertion loss. One of the gaps 512 is shown in the schematic illustration of FIG. 6. In the illustrative embodiment of the invention, the gaps 512 have a maximum dimension less than 5 μm, more preferably less than 2.5 μm and most preferably in the range between 1.5 μm and 2 μm. Such small size gaps reduce the optical loss between the polymeric waveguide structures of the device.

The index matching fluid that fills the gaps 512 can be realized from perfluorocarbon (PFC) fluid manufactured and sold by the 3M Company of St. Paul, Minn. Such PFC fluid is chemically very stable and non-toxic, has a transparency that extends into the UV, and has a refractive index that matches the refractive index of the polymers of the waveguide structures of the device.

The index matching fluid that fills the gap 512 can also be realized from Decahydronaphthalene (also known as decalin), which is a highly characterized spectrographic solvent manufactured and sold by Eastman Kodak Company of Rochester, N.Y. It is chemically quite stable under intense 1064 nm and 1315 nm irradiation and harmonics as well as most of the near IR-VIS-UV range. The primary advantage of decalin over the perfluorocarbons is its higher refractive index, typically resulting in Fresnel losses of roughly 0.01% and greatly reducing etaloning problems.

The index matching fluid that fills the gap 512 can also be a mixture of mineral oil and hydrogenated terphenyls manufactured by Cargille Laboratories, Inc. of Cedar Grove, N.J. Its primary advantages are that the refractive index can be adjusted with high accuracy over a range of values near 1.5 and also that its low vapor pressure makes it easy to contain over long periods of time.

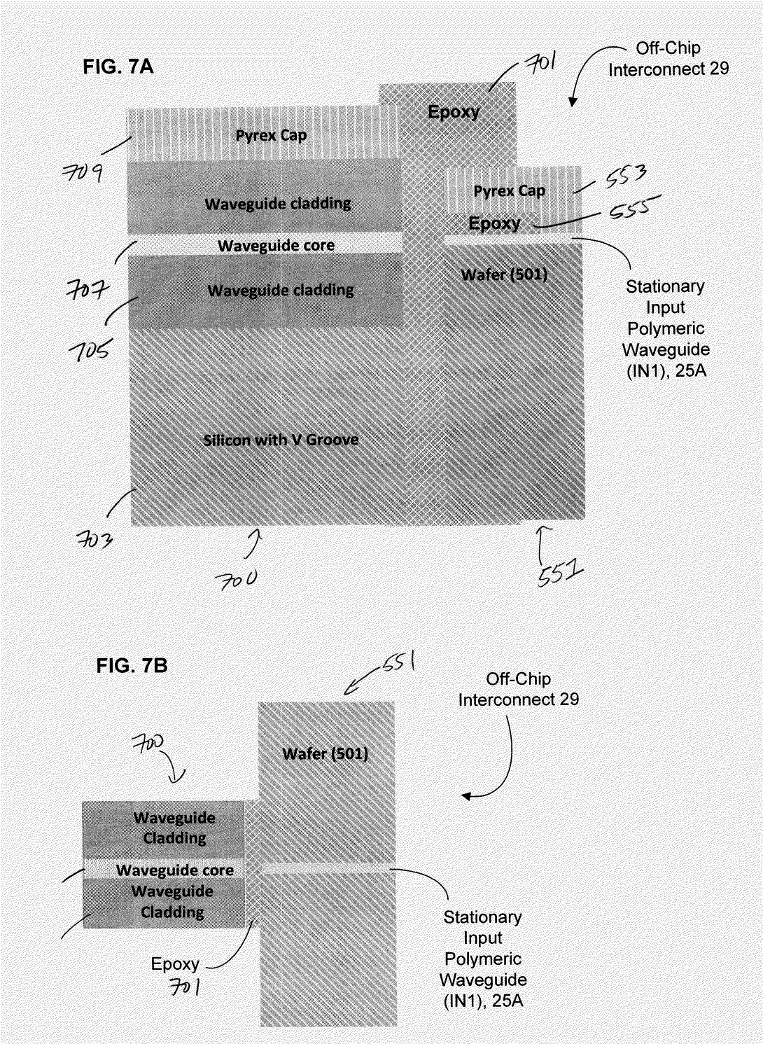

An exemplary off-chip coupler is shown in FIGS. 7A and 7B, which includes a connector assembly 700 bonded by epoxy 701 (or other suitable adhesive) to the edge of chip-scale package 551. The chip-scale package 551 includes end-product wafer 501 with a top pyrex cap 553 bonded thereto by an epoxy 555 (or other suitable adhesive). The connector assembly 700 includes a silicon with v-groove substrate 703 supporting the waveguide cladding 705 and core 707 of the terminal end of a fiber optic cable. The waveguide cladding 705 and core 707 are secured in place in the v-groove (not shown) of the substrate 703 by a top pyrex cap 709. In the preferred embodiment, the connector assembly 700 is glued in place such that the core 707 of the terminal end fiber optic is aligned to the stationary input polymeric waveguide 25A as shown. Similar structures can be used for interfacing to the other stationary input and stationary output polymeric waveguide structures integral to the wafer 501.

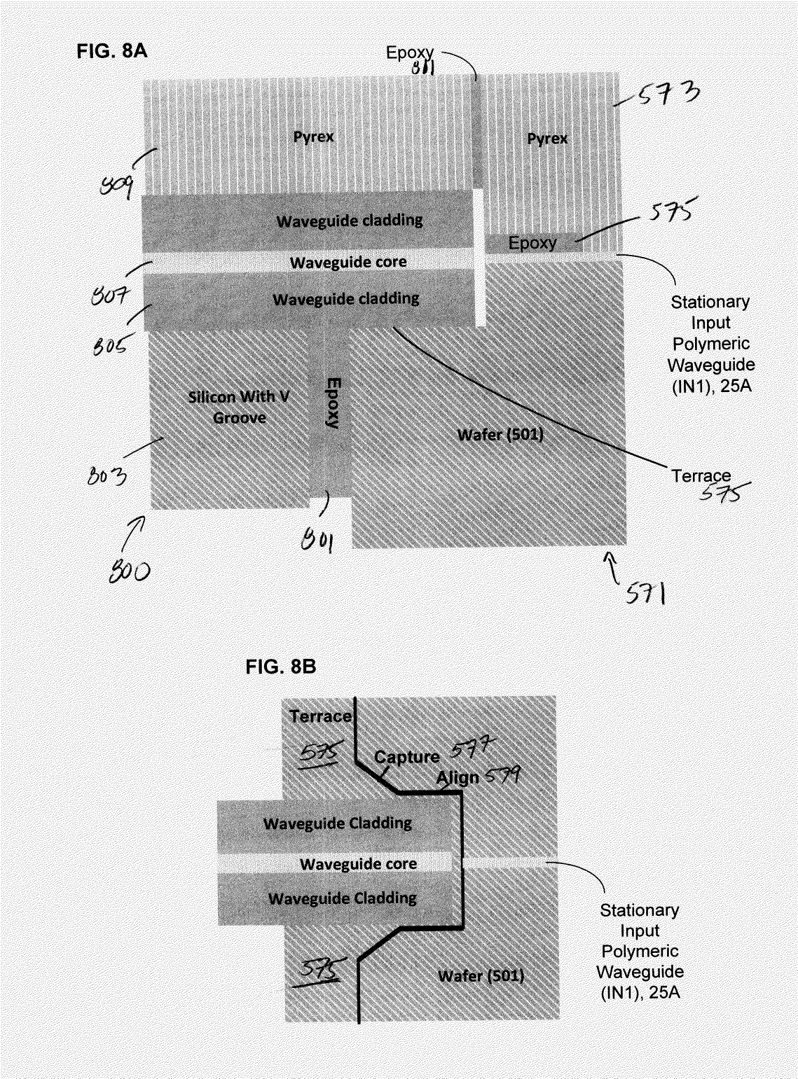

An alternate off-chip coupler is shown in FIGS. 8A and 8B, which includes a connector assembly 800 bonded by epoxy 801 (or other suitable adhesive) to the edge of chip-scale package 571. The chip-scale package 571 includes end-product wafer 501 with a top pyrex cap 573 bonded thereto by an epoxy 575 (or other suitable adhesive). The connector assembly 800 includes a silicon with v-groove substrate 803 supporting the waveguide cladding 805 and core 807 of the terminal end of a fiber optic cable. The waveguide cladding 805 and core 807 are secured in place in the v-groove (not shown) of the substrate 803 by a top pyrex cap 809. The top surface of the end product wafer 501 includes a terrace feature 575 as well as a capture feature 577 and align feature 579 at its edge. The terrace feature 575 provides a support surface that supports the waveguide cladding 805 and core 807 of the connector assembly 800. The depth of the terrace feature 575 is designed for the particular cladding and core of the connector assembly 800 such that the core 807 is vertically aligned with the stationary input polymeric waveguide 25A integral to the wafer 501. The capture feature 577 and align feature 579 are designed for the particular cladding and core of the connector assembly 800 and provide for efficient capture and lateral alignment of the core 807 with the stationary input polymeric waveguide 25A integral to the wafer 501. Similar structures can be used for interfacing to the other stationary input and stationary output polymeric waveguide structures integral to the wafer 501.

As described above, the polymeric waveguide structures of the device are adapted such that the stationary ingress polymeric waveguide structures 25A, 25B, 25C interface to the ingress end 19 of the polymeric waveguide structure 17 of the platform 15 at different rotative positions of the platform 15, while the egress end 21 of the polymeric waveguide structure 17 interfaces to the stationary egress polymeric waveguide structures 27A, 27B, 27C at the different rotative positions of the platform 15 to provide for the desired switching architecture.

It is contemplated that mechanical alignment mechanisms (mechanics stops) and active alignment mechanisms (such as electrical, piezo-resistive, magnetic and optical position sensors) can be used in conjunction with closed-loop control to limit misalignment of the waveguide structures in the different rotative positions of the rotatable platform 15. By limiting such misalignment, optical loss is reduced.

The optical switching device can employ blocking and non-blocking architectures as desired. A switching architecture is said to be non-blocking if any unused input port can be connected to any unused output port. Thus a non-blocking switching architecture is capable of realizing every interconnection pattern between the inputs and the outputs. If some interconnection patterns cannot be realized, the switching architecture is said to be blocking

In an alternate embodiment, the interdigitated design of the rotor and stator fingers of the device can be adapted to provide for translation (i.e., lateral movement instead of rotation) of the electrostatically-driven platform 15. In this configuration, the lateral movement can be induced by application differential voltage signals to the fingers as is well know in the art. For example, U.S. Pat. No. 7,003,188 to Hsu et al. describes an interdigitated design of rotor and stator fingers that provide for lateral movement of a light-guide platform.

There have been described and illustrated herein several embodiments of a MEMS-based device employing an electrostatically-actuated movable platform supporting at least one polymeric waveguide integrally formed thereon for transparent optical switching. While particular embodiments of the invention have been described, it is not intended that the invention be limited thereto, as it is intended that the invention be as broad in scope as the art will allow and that the specification be read likewise. Thus, while particular materials and process methodologies have been disclosed, it will be appreciated that other materials and process methodologies can be used as well. In addition, while particular types of comb-drive electrostatic actuators have been disclosed, it will be understood that other types of comb-drive electrostatic actuators can be used. Furthermore, while particular optical switching configurations have been disclosed, it will be understood that the methodologies described herein can be used to design a wide variety of optical switching configurations. For example, multiple moveable platforms can be integrated on the same wafer and coupled together via waveguides for more complex designs. It will therefore be appreciated by those skilled in the art that yet other modifications could be made to the provided invention without deviating from its spirit and scope as claimed.

What is claimed is:

1. An optical switching device comprising:
a substrate;
a moveable platform driven by electrostatic actuation provided by a set of rotor fingers and stator fingers, wherein the moveable platform, rotor fingers and stator fingers are integrally formed on the substrate;
a plurality of stationary input polymeric waveguides integrally formed on the substrate;
a plurality of stationary output polymeric waveguides integrally formed on the substrate; and
at least one polymeric waveguide integrally formed on the moveable platform, the polymeric waveguide operably coupled to a select one of the stationary input polymeric waveguides and a select one of the stationary output polymeric waveguides in different positions of the moveable platform as driven by electrostatic actuation provided by the rotor fingers and stator fingers;
wherein the rotor fingers and stator fingers comprise a patterned conductive material, and
wherein the stationary input polymeric waveguides, the stationary output polymeric waveguides and the polymeric waveguide formed on the movable platform are each defined by a multilayer polymer sandwich for guiding light propagating therein, and the same conductive material of the rotor fingers and stator fingers is disposed under the multilayer polymer sandwich of the polymer waveguide formed on the moveable platform over its entire length.

2. An optical switching device according to claim 1, further comprising:
a sacrificial oxide layer that is deposited on or part of the substrate, wherein the moveable platform and rotor fingers are part of a rigid body suspended over the substrate by etching of the sacrificial oxide layer.

3. An optical switching device according to claim 2, wherein:
the rigid body includes suspenders that extend between the moveable platform and corresponding anchors that are rigidly coupled to the substrate.

4. An optical switching device according to claim 1, wherein:
the multilayer polymer sandwich comprises a polymer selected from the group consisting of: co-polymers of tetrafluoroethylene (TFE) and 2,2,4-trifluoro-5-trifluoromethoxy-1,3-dioxole (TTD); and a perfluoroploymer.

5. An optical switching device according to claim 4, wherein:
the perfluporopolymer comprises randomly copolymerized units of tetrafluoroethylene, perfluoro (alkyl vinyl) ether and a cure site monomer.

6. An optical switching device according to claim 5, wherein:
the cure site monomer is selected from the group consisting of: vinyldene fluoride; perfluoro-(8-cyano-5-methyl-3,6-dioxa-1-octene, bromotetrafluorobutene); perfluoro-(2-phenoxypropyl vinyl ether); and poly(perfluorinated butenyl vinyl ether).

7. An optical switching device according to claim 1, further comprising:
a metal mask layer overlying the multilayer polymer sandwich.

8. An optical switching device according to claim 7, wherein:
the metal mask layer comprises aluminum.

9. An optical switching device according to claim 1, wherein:
the stationary input polymeric waveguides and the polymeric waveguide formed on the moveable platform are separated from one another by a first set of gaps in the respective positions of the moveable platform, and the polymeric waveguide formed on the moveable platform is separated from the stationary output polymeric waveguides by a second set of gaps in the respective positions of the moveable platform;
wherein the first set of gaps and the second set of gaps have a maximum dimension less than 5 μm.

10. An optical switching device according to claim 9, wherein:
the maximum dimension of the first and second sets of gaps is less than 2.5 μm.

11. An optical switching device according to claim 9, wherein:
the maximum dimension of the first and second sets of gaps is in the range between 1.5 μm and 2 μm.

12. An optical switching device according to claim 9, wherein:
the first set of gaps as well as the second set of gaps are filled by an index matching fluid.

13. An optical switching device according to claim 1, wherein:
the multilayer polymer sandwich comprises a polymer core sandwiched between an upper polymer cladding and a lower polymer cladding.

14. An optical switching device according to claim 13, wherein:
the polymer core of the multilayer polymer sandwich has a height in the range between 3 μm and 6 μm.

15. An optical switching device according to claim 13, wherein:
the polymer core of the multilayer polymer sandwich has a height on the order of 4 μm.

16. An optical switching device according to claim 13, wherein:
thickness of the lower polymer cladding for the polymeric waveguides of the device is controlled over the polymeric waveguides to provide for vertical alignment of the polymeric waveguides of the device.

17. An optical switching device according to claim 13, wherein:
a buffer layer is disposed under the lower polymer cladding of certain polymeric waveguides of the device to provide for vertical alignment of the polymeric waveguides of the device.

18. An optical switching device according to claim 1, wherein:
the set of rotor fingers and stator fingers provide for rotational movement of the moveable platform about a rotational axis.

19. An optical switching device according to claim 18, wherein:
the moveable platform rotates about the rotational axis in both a clockwise direction and a counterclockwise direction.

20. An optical switching device according to claim 1, wherein:
the set of rotor fingers and stator fingers provides for translation of the moveable platform in at least one direction.

21. An optical switch device according to claim 1, wherein:
the set of rotor fingers and stator fingers provide for course movement and fine movement of the moveable platform.

22. A method of forming an optical switching device comprising:
depositing and patterning a conductive material on a substrate;
depositing and patterning a multilayer polymer sandwich, wherein first and second parts of the patterned multilayer polymer sandwich are formed over the substrate and operate to guide light propagating therein, and a third part of the patterned multilayer polymer sandwich is formed over the patterned conductive material and operate to guide light propagating therein; and
covering the first, second and third parts of the patterned multilayer polymer sandwich with protective material while forming a moveable platform as well as a set of rotor fingers and stator fingers on the substrate, wherein the rotor fingers and stator fingers provide for electrostatic actuation of the moveable platform and include the patterned conductive material;
wherein the first and second parts of the patterned multilayer polymer sandwich define a plurality of stationary input polymeric waveguides as well as a plurality of stationary output polymeric waveguides, and the third part of the patterned multilayer polymer sandwich defines a polymeric waveguide integral to the moveable platform.

23. A method according to claim 22, wherein:
the patterned conductive material is disposed under the multilayer polymer sandwich of the polymer waveguide integral to the moveable platform over its entire length.

24. A method according to claim 22, wherein:
the polymeric waveguide integral to the moveable platform is operably coupled to a select one of the stationary input polymeric waveguides and a select one of the stationary output polymeric waveguides in different positions of the moveable platform as driven by electrostatic actuation provided by the rotor fingers and stator fingers.

25. A method according to claim 22, wherein:
a sacrificial oxide layer is deposited on or is part of the substrate.

26. A method according to claim 25, further comprising:
etching of the sacrificial oxide layer to define a rigid body suspended over the substrate, the rigid body including the moveable platform and rotor fingers.

27. A method according to claim 26, wherein:
the rigid body includes suspenders that extend between the moveable platform and corresponding anchors that are rigidly coupled to the substrate.

28. A method according to claim 22, wherein:
the protective material protects the underlying patterned multilayer polymer sandwich from etchant used in the etching of the sacrificial oxide layer.

29. A method according to claim 28, wherein:
the etchant comprises an HF etchant and the protective material comprises a mask of photoresist.

30. A method according to claim 22, wherein:
the multilayer polymer sandwich comprises a polymer selected from the group consisting of: co-polymers of tetrafluoroethylene (TFE) and 2,2,4-trifluoro-5-trifluoromethoxy-1,3-dioxole (TTD); and a perfluoroploymer.

31. A method according to claim 30, wherein:
the perfluporopolymer comprises randomly copolymerized units of tetrafluoroethylene, perfluoro (alkyl vinyl) ether and a cure site monomer.

32. A method according to claim 31, wherein:
the cure site monomer is selected from the group consisting of: vinyldene fluoride; perfluoro-(8-cyano-5-methyl-3,6-dioxa-1-octene, bromotetrafluorobutene); perfluoro-(2-phenoxypropyl vinyl ether); and poly(perfluorinated butenyl vinyl ether).

33. A method according to claim 22, wherein:
a metal mask layer is used to patterned the multilayer polymer sandwich.

34. A method according to claim 33, wherein:
the metal mask layer comprises aluminum.

35. A method according to claim 22, wherein:
the stationary input polymeric waveguides and the polymeric waveguide integral to the moveable platform are separated from one another by a first set of gaps in the respective positions of the moveable platform, and the polymeric waveguide integral to the moveable platform is separated from the stationary output polymeric waveguides by a second set of gaps in the respective positions of the moveable platform;
wherein the first set of gaps and the second set of gaps have a maximum dimension less than 5 μm.

36. A method according to claim 35, wherein:
the maximum dimension of the first and second sets of gaps is less than 2.5 μm.

37. A method according to claim 35, wherein:
the maximum dimension of the first and second sets of gaps is in the range between 1.5 μm and 2 μm.

38. A method according to claim 35, further comprising:
filling the first set of gaps as well as the second set of gaps with an index matching fluid.

39. A method according to claim 22, wherein:
the multilayer polymer sandwich comprises a polymer core sandwiched between an upper polymer cladding and a lower polymer cladding.

40. A method according to claim 39, wherein:
the polymer core of the multilayer polymer sandwich has a height in the range between 3 μm and 6 μm.

41. A method according to claim 39, wherein:
the polymer core of the multilayer polymer sandwich has a height on the order of 4 μm.

42. A method according to claim 39, wherein:
thickness of the lower polymer cladding for the polymeric waveguides of the device is controlled over the polymeric waveguides to provide for vertical alignment of the polymeric waveguides of the device.

43. A method according to claim 39, wherein:
a buffer layer is disposed under the lower polymer cladding of certain polymeric waveguides of the device to provide for vertical alignment of the polymeric waveguides of the device.

44. A method according to claim 22, further comprising:
subsequent to the patterning the conductive material, depositing and patterning a mask that overlies and contacts the conductive material, wherein the patterning of the mask defines a first open area, a second open area, and a third open area;
wherein the first open area is used in an etching operation to define the moveable platform;
wherein the second open area exposes conductive material that underlies the polymeric waveguide integral to the moveable platform; and
wherein the third open area is used in an etching operation to define the rotor fingers and stator fingers of the optical switching device.

45. A method according to claim 44, wherein:
the patterning of the mask defines a fourth open area that underlies at least one stationary input polymeric waveguides and/or stationary output polymeric waveguide.

46. A method according to claim 44, wherein:
the protective material is patterned to define first and second open areas aligned to the corresponding first and second open areas of the mask.

47. A method according to claim 44, wherein:
the mask protects against a release etchant that defines the moveable platform.

48. A method according to claim 47, wherein:
the release etchant comprises an HF etchant.

49. A method according to claim 47, wherein:
the mask comprises a material selected from the group including aluminum oxide and aluminum fluoride.
